(19) United States
(12) Patent Application Publication
(10) Pub. No.: US 2008/0174104 A1
(43) Pub. Date: Jul. 24, 2008

(54) Secure documents - methods and applications

(75) Inventor: Pauline Ozoemena Ukpabi, Oshkosh, WI (US)

Correspondence Address: APPLETON PAPERS INC.;LAW DEPARTMENT, 825 E. WISCONSIN AVENUE, PO BOX 359, APPLETON, WI, 54912-0359, US

(73) Assignee: Appleton Papers Inc.

(21) Appl. No.: 12/009,331

(22) Filed: Jan. 17, 2008

Related U.S. Application Data
(60) Provisional application No. 60/881,193, filed on Jan. 19, 2007.

(51) Int. Cl. B42D 15/00; B29C 59/16

(52) U.S. Cl. 283/93; 283/70; 264/446

(57) ABSTRACT

The invention teaches a paper substrate having a laser treated area which has benefits for anti copy, copy deterrence and/or copy detection applications. The laser treatment may be in the form of a dense array of a plurality of microperforations which may or may not be visible to the naked eye or in form of fine graphics on the paper surface incorporated via partial ablations. The laser treated area serves as an authenticated field. In one aspect, the authentication field when copied on reprographic equipment reproduces as a field of dark separated dots. The authentication field optionally can take the form of various shapes including alphanumeric characters or other patterns. In an alternate aspect the laser treated area is an area of laser-formed partial ablations creating a synthetic watermark.

### SECURE DOCUMENTS

### Methods and Applications

This application under 35 U.S.C 111(a) claims priority to U.S. Ser. No. 60/881,193 filed Jan. 19, 2007.

### BACKGROUND OF THE INVENTION

1. Field of the Invention

The present invention relates to paper generally. More particularly, the present invention also relates to secure substrates and generally to the field of anti-copy, anti-counterfeiting and authentication devices/methods and image survivable security features.

2. Description of the Related Art

A variety of secure documents are known used in bank notes, credit cards, tickets, title documents, and similar instruments of value. A variety of security tokens or authentication devices are also known.

Australian Patent No. 488,652 (Application No. 73762/74) filed Sep. 26, 1973 by Sefton Davidson Hamann et al., assigned to the Commonwealth Scientific and Industrial Research Organization teaches a security token comprising a laminate of at least two layers of plastic sheeting. Positioned between the sheeting is an optically variable device such as a diffraction grating, liquid crystal, moiré patterns and similar patterns produced by cross-gratings with or without superimposed, refractive, lenticular and transparent grids. These devices yield variable interference patterns.

U.S. Pat. Nos. 5,995,618, 6,819,775, 6,249,588 and 7,058,202 teach methods for authenticating documents using the intensity profile of moiré patterns. These authentication devices are generally produced using printing techniques but may also be produced by perforations. The various dot screens and perforations taught in these patents while useful as authentication devices do not teach copy detection, copy deterrence or anticopy systems.

It is one object of the present invention to teach distinctive forms of a document or token with microperforations or marks that find applications as anticopy, copy detection and copy deterrent systems.

Several different methods are used to perforate substrates including the use of wheels, pressurized water jets, heat treatment and laser systems. Applications for microperforated systems are found in such areas as cigarette filters, labels, card stock, index divider sheet assemblies, foldable/tearable sheets, spiral notebooks, composites, damping materials, envelopes and packaging. Microperforation may be done on plastic or metal films, nonwoven assemblies and textiles. When it is done on paper, it could be to introduce tearability along a line as in U.S. Pat. No. 6,146,731, to make attention-attracting 3D cards as in U.S. Pat. No. 6,044,490 or for some other applications such as cigarette filters as described in U.S. Pat. Nos. 4,302,654, 3,742,182 and 4,174,719. Filmic applications are described in U.S. Pat. Nos. 6,495,231, 6,468,661 and 6,294,267.

U.S. Pat. No. 4,297,559 described a system for precision perforation of moving webs employing a pulsed, fixed focus laser beam wherein the laser pulses are automatically controlled in pulse repetition frequency and in pulse width to provide a desired preset web porosity. Closed loop circuitry responsive to web speed, sensed web porosity, and a porosity preset signal provides the precise system control needed to produce and maintain the preset porosity over a wide range of system variables. The illustrative embodiment described is particularly useful for perforating paper, film, and like materials where a high degree of product uniformity and porosity control is desired.

Anticopy or copy deterrent documents are typically produced using printing, lamination or coating techniques. In general, these systems involve manipulation of the optical properties of the substrate (color, reflectance, etc) to change its interaction with the copying system's light source.

U.S. Pat. Nos. 3,887,742 and 4,025,673 issued to Reinnagel described copy resistant documents and/or methods for treating or producing original documents to inhibit, if not preclude, the reproduction of such documents by copying processes. The techniques involved favoring the visual response of the human eye over the physical response of a copying machine so that the graphical information imprinted on the document background is readily perceptible by the human eye but imperceptible by the sensor and associated processes of a copying machine.

Wallace in U.S. Pat. No. 5,707,083 described security documents with multi-angled voids which are substantially copy proof even when using modern digital color copiers and which may also be constructed to be scanner and image friendly. These documents contain printed colored background lines at a first angle and colored VOID lines at a second angle, the second angle being at least 20° different than the first angle. All of the background and VOID lines have a black content of at least 15% and a density of 7-22%. For scanner and image friendly documents the density must be between about 10-12%. All of the lines in the areas have an average maximum line width variation of about 0.0005 inches. The background and VOID lines typically all have a frequency of between about 97-103 lines per inch. The document includes first and second quality control sections adjacent opposite edges of the document, the first quality control section having a density that is about 2% greater than the main body of the document, and the second quality control section having a density that is about 5% greater.

While the documents listed above employ printing techniques and/or the optical properties of the substrate, U.S. Pat. No. 4,786,084 described a technique involving application of a volumetric holographic or surface holographic refraction grating photocopy prevention film to the document needing protection. The refraction grating either causes normally scattered light to be focused toward the photoreceptors of a photocopy machine or causes light normally reflected toward the receptors to be scattered away from the receptors.

Sruggs in U.S. Pat. No. 6,189,934 described an anti-copy layer utilizing spectral fragments. This anti-copy layer or film for documents is substantially transparent to the legitimate user, comprising a multiplicity of small fragments of spectral material embedded within an optically clear coating, wherein multi-angular illumination of the fragments by a copy apparatus generates sufficient amounts of visual noise in a copy as to prevent true-copy replication of the documents.

While these systems may work well for copy detection, the substrate is usually colored as in U.S. Pat. Nos. 3,887,742 and 4,025,673 or has to go through a film lamination process following printing to ensure the document functions as desired. When a dye is used to achieve the copy detection feature, the substrate has a shelf life that depends on the durability of the dye and in most cases stops functioning after a few months.

It is another object of the present invention to teach distinctive forms of a document or token with image survivable features. These features are permanent and cannot be erased or washed out by solvents or other means. As mentioned above, the use of dyes to create such features usually yields features that have very limited shelf life.

It is another object of the present invention to teach durable ghost-type features which are integral to the paper substrate.

### BRIEF DESCRIPTION OF THE DRAWINGS

FIG. 1 is a micrograph of substrate with microperforations.

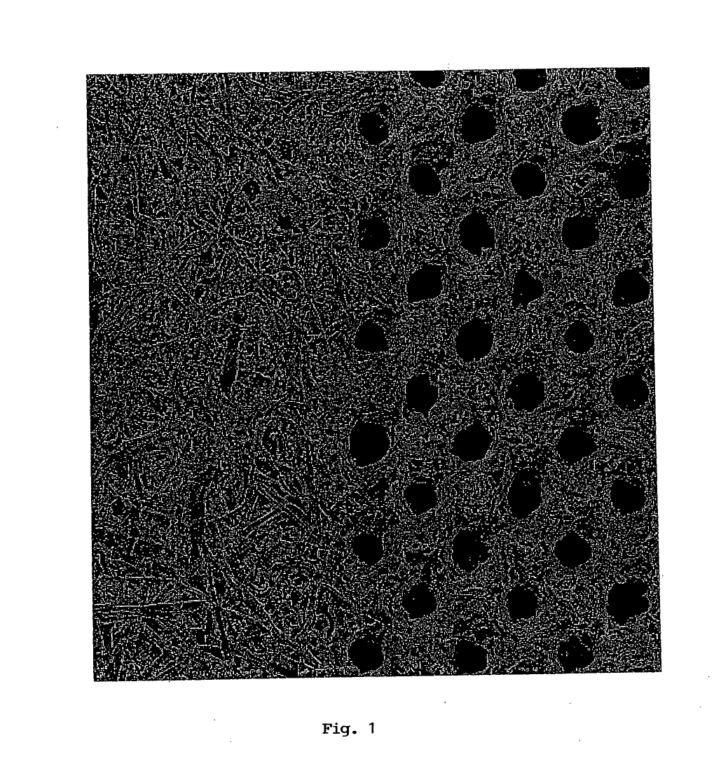

### DETAILED DESCRIPTION

The present invention teaches a paper substrate perforated using a laser beam. In one embodiment the invention is a perforated paper substrate.

In one desirable form, the invention consists of an array of a plurality of laser-formed microperforations (20-120, more preferably 80-120 microns in diameter) with wide separations (>600 microns) between perforations. Such systems yield security features which may only be visible when the paper is tilted at an angle or held up to the light depending on the size of the perforation. The larger perforations are more readily visible. Such systems show up as individual/separated black dots when copied or scanned. These are image survivable features. The dots indicate the document was scanned or copied hence the copy indicating property of the feature. The black dots distinguish the scanned or copied documents from the original. Additionally, the porosity of the original document can be verified to prove authenticity.

In another desirable form, the invention consists of an array of a plurality of laser-formed microperforations (20-120, more preferably 80-120 microns in diameter) with narrow separations (<600 microns) between perforations. Such systems yield visible security features that may be transparent depending on the density rate of the perforations per unit area (co-pending application under 35 U.S.C. § 111(a) Ser. No. 11/655,101 filed Jan. 19, 2007 by Pauline Ukpabi, incorporated herein by reference). Such systems may show up as individual/separated black dots when copied or scanned. In general though, the systems show up as a dark field when scanned or copied because the perforations are so close together that the land area or the separation between perforation is obscured especially when the density rate of the perforations per unit area is high. These are also image survivable features and show copy indicating/anticopy properties as mentioned above.

The microperforations can range in size from 10 microns to 150 microns.

In another desirable form, the invention consists of very fine graphics etched onto the surface of the paper substrate in such a way that the paper is not completely pierced. These are partial ablations and the graphics are visible only when the paper substrate is tilted and cannot be reproduced by copying or scanning because of the low contrast between the background and the graphics.

In a preferred embodiment of the invention the paper is uncoated. The laser system burns off some of the paper surface to create the mark (partial ablation) that yields ghost type watermarks because of the low contrast between the graphics and the background.

This embodiment encompasses a method for creating a synthetic watermark in a paper substrate which comprises providing a paper substrate, applying a laser to the substrate to form partial ablations in the substrate in an area array having a density of at least 600 ablations per square centimeter.

The method further comprises verifying the synthetic watermark by illuminating the surface with a light source at an angle relative to the surface of the substrate and viewing the surface at substantially the same angle relative to the surface as the light source, the laser ablations appearing lighter than the substrate outside of the ablated area.

In an alternative embodiment of the invention, the paper is coated and the laser burns off some of the coating and/or substrate to yield ghost-type watermarks or features.

In another embodiment of the invention, the paper is coated and the laser beam interacts with some component of the coating to produce a contrast or a color which is easily visible.

The separation between the holes affects anticopy properties of the original. Obscuring of a copy, meaning yielding a black copied or black scanned image is a function of smaller separations between the holes. To ensure that the paper retains some strength and does not fall apart as a result of the many or thousands of holes drilled through it, the paper could be stabilized via saturation with latex or lamination to a filmic substrate.

The illumination source and the strength of the illumination source greatly impact the ability of the microperforated substrate to yield a dark copy on exposure to the copier or scanner illumination. White light seems to have a better propensity for giving a black image. Green light, on the other hand, gives no significant or at best a much weaker image than seen with white light. Yellow light acts more like white light in giving darker images. To ensure that the microdrilled paper works well in all systems and with all types of illumination, it may be necessary to back the substrate with a black or dark colored substrate. This backing absorbs all of the light that goes through the perforation regardless of the type of illuminant and hence yields a black copy all the time.

In this aspect, the invention discloses a method of verifying a document comprising providing a paper substrate having an array of a plurality of laser formed microperforations separated by a land area, the array of microperforations having a diameter in the range of 80 to 120 microns, the land area separating adjacent microperforations being at least 600 microns, wherein the paper substrate when copied on reprographic equipment reproduced as a field of visible dots.

In an alternate aspect the paper substrate includes in addition a dark colored backing sheet laminated to the surface of the paper substrate, wherein the dark colored backing sheet augments the contrast of the microperforations in the substrate so as to make the microperforations visible.

The microperforations on reprographic equipment including, but not limited to, xerographic copiers and printers, lasers printers and copiers, ink jet printers and copiers, bubble jet printers and copiers, reproducers as a black dot. The black copy of the microperforation occurs since the scanning light is absorbed into the depth of the perforation.

The laser microperforated paper or laser ablated paper is useful for authentication purposes to identify original documents.

The depth of the perforation also determines how dark the copied or scanned version turns out. The thicker the paper and hence the deeper the perforation, the longer it takes for the light to hit the backing. If this back reflection does not occur in the few seconds it takes the copier or scanner to complete its work, a darker copy would result. Paper and/or really thin substrates do not have enough depth for any hole drilled through them to hold the light longer than a microsecond. The light is therefore reflected back to the copier/scanner and a white copy results unless the copier cover is left open and the light is lost into the air.

A CO₂ laser system is usually employed for best results. However, other laser systems including UV and fiber lasers would yield similar results.

While size is important, the separation between the holes plays a major role in determining the transparency of the perforated material. The wider the separation between the holes, the less transparent the paper is. As an example, samples with 100 micron-sized holes spaced 600 microns apart (center to center) were almost as white/opaque as the base paper with no perforations. Samples with 100 micron-sized holes spaced 400 microns apart were transparent enough that one could easily read any writing placed behind the treated area. Similar observations were made for samples with 100 micron-sized holes spaced 200 microns apart.

The laser treated field of the invention can be created using partial ablations where only some portion of the paper surface is removed, however the paper is not completely pierced in such alternative. A synthetic watermark can be created in such manner.

The array of partial ablations can be visible or even somewhat invisible (like ghost type watermarks which can be viewed when the paper is tilted at an angle). With partial ablations, some portion of the paper surface is removed at the dot area where the laser is directed, however the paper is not completely pierced in such alternative. The remaining land areas then are essentially raised areas between the respective partial ablations. The density rates of the partial ablation would be similar to or higher than with microperforations. A synthetic watermark can be created in such manner.

What is claimed is:

1. A paper substrate having an authentication field area comprising an array of a plurality of laser-formed microperforations separated by a land area, the array of microperforations having diameter in the range 80-120 microns, the land area separating adjacent microperforations being at least 600 microns.

2. The paper substrate according to claim 1 wherein the plurality of laser microperforations are not readily ascertainable by the unaided eye when viewed at an angle approximately perpendicular to the surface of the substrate using reflected light,
said microperforations being visible to the unaided eye when viewed at an angle approximately perpendicular to the surface of the substrate but using light transmitted through the substrate,
whereby when the surface is illuminated by a light source located at an angle relative to the surface of the substrate and viewed from a position at substantially the same angle relative to the surface as the light source, the microperforations appear not readily ascertainable and not contrasting with the surface.

3. The paper substrate according to claim 1 wherein the plurality of laser microperforations are visible to the unaided eye as individual dots separated by land area.

4. The paper substrate according to claim 1 wherein the paper substrate when copied on reprographic equipment reproduces as a field of separated dots.

5. The paper substrate according to claim 1 including in addition a dark colored backing sheet laminated to a surface of the paper substrate, the dark colored backing sheet augmenting the contrast of the microperforations in the substrate.

6. The paper substrate according to claim 2 wherein at least the area of the paper substrate that is microperforated includes in addition a latex material applied to the substrate to strengthen the paper.

7. The paper substrate according to claim 2 wherein the authentication field is a square or rectangular area.

8. The paper substrate according to claim 2 wherein the authentication field is in the shape of alphanumeric characters.

9. The paper substrate according to claim 8 wherein the authentication field is a geometric or artistic shape.

10. A paper substrate having a laser ablated field area comprising an array of a plurality of laser-formed partial ablations that do not completely pierce the paper, the array having a density rate of ablations of at least 600 ablations per square centimeter, the partial ablations are not readily ascertainable by the unaided eye when viewed at an angle approximately perpendicular to a surface of the substrate using reflected light, and not readily ascertainable when viewed at an angle approximately perpendicular to the surface of the substrate but using light transmitted through the substrate, whereby when the surface is illuminated by a light source located at an angle relative to the surface of the substrate and viewed from a position at substantially the same angle relative to the surface as the light source the laser ablations appear lighter than the substrate outside the laser ablated field area.

11. A method of verifying a document comprising providing a paper substrate having an array of a plurality of laser formed microperforations separated by a land area, the array of microperforations having a diameter in the range of 80 to 120 microns, the land area separating adjacent microperforations being at least 600 microns, wherein the paper substrate when copied on reprographic equipment reproduces as a field of visible dots.

12. The method according to claim 11 wherein the paper substrate includes in addition a dark colored backing sheet laminated to the surface of the paper substrate, wherein the dark colored backing sheet augments the contrast of the microperforations in the substrate so as to make the microperforations visible.

13. A method for creating a synthetic watermark in a paper substrate which comprises providing a paper substrate, applying a laser to the substrate to form partial ablations in the substrate in an area array having a density of at least 600 ablations per square centimeter.

14. The method of claim 13 further comprising verifying the synthetic watermark by illuminating the surface with a light source at an angle relative to the surface of the substrate and viewing the surface at substantially the same angle relative to the surface as the light source, the laser ablations appearing lighter than the substrate outside of the ablated area.
